(19) United States
(12) Patent Application Publication
(10) Pub. No.: US 2006/0271392 A1
(43) Pub. Date: Nov. 30, 2006

(54) Circumstance information management system and management method therefor

(75) Inventors: Daisuke Komaki, Yokohama (JP); Yoshihiro Mizuno, Yokohama (JP); Ryusuke Ikegami, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/412,162

(22) Filed: Apr. 25, 2006

(30) Foreign Application Priority Data
May 31, 2005 (JP) 2005-159839

(51) Int. Cl. G06Q 99/00

(52) U.S. Cl. 705/1

(57) ABSTRACT

A history concerning circumstances surrounding each item during distribution is obtained from a reusable measuring apparatus attached to the item or measuring apparatuses placed in locations such as rooms. Information about items of products in a distribution channel are managed by associating position information indicating the locations at both ends of a place where circumstance information is measured with measuring apparatuses with the information indicating the measuring apparatuses. When items are moved during distribution, information contained in a tag attached to the items is read at the locations at both ends of the place and is managed. To obtain information about circumstances surrounding an item at a particular place in the distribution channel, values measured with the measuring apparatuses during a relevant period are obtained on the basis of the position information indicating the locations at both ends of the particular place and on the read dates and times.

### CLAIM OF PRIORITY

The present application claims priority from Japanese application 2005-159839 filed on May 31, 2005, the content of which is hereby incorporated by reference into this application.

### FIELD OF THE INVENTION

The present invention relates to a circumstance information management system and method for storing and searching information about circumstances surrounding products such as temperature and humidity in product manufacturing, distribution, and stages.

### BACKGROUND OF THE INVENTION

Circumstance information such as temperature and humidity is measured today with apparatuses such as temperature sensors and humidity sensors provided in places such as warehouses or factories or on truck beds. If an abnormality is found in circumstances such as temperature or humidity, products are inspected and/or discarded or some other actions are taken at the location where the abnormality has occurred.

Japanese Patent Laid-Open No. 2004-315154 describes a method in which a data carrier including an ID tag containing ID information and means for measuring and transmitting circumstance information such as temperature and humidity is attached to products, the circumstance information such as temperature and humidity measured and stored in the data carrier is transmitted to a data server in each of distribution stages such as packaging, cargo handling, transport, and storage stages, the circumstance information concerning each product item in the distribution is managed on the data server, and filtering is performed on the data server for detecting circumstance data such as temperature that does not satisfies a quality assurance standard, thereby finding defective products.

There is a growing demand for tracking down the range of defective products or ex-post investigation of cause of defects by keeping track of circumstance information concerning each item of products, such as temperature and humidity, as in the technique described in Japanese Patent Laid-Open No. 2004-315154. However, the method described in Japanese Patent Laid-Open No. 2004-315154 requires the attachment of an expensive data carrier to each item and therefore it is difficult to introduce the method in many cases due to the costs.

The costs may be reduced by reusing expensive data carriers. However, the method described in Japanese Patent Laid-Open No. 2004-315154 does not allow data carriers to be reused because the method manages items and data carries by associating them in a one-to-one relationship and, if the data carriers were reused, it would be impossible to determine which item is associated with circumstance information such as temperature or humidity obtained with a data carrier.

An object of the present invention is to provide a method or system capable of obtaining and managing circumstance histories such as a temperature or humidity history of each item by using circumstance information obtaining apparatuses such as temperature sensors or humidity sensors placed in particular locations such as warehouses, factories, and truck beds.

Another object of the present invention is to provide a method or system capable of obtaining and managing circumstance histories for each item in a form that allows circumstance information obtaining apparatuses to be reused even if they are attached to items or containers that moves along with items.

### SUMMARY OF THE INVENTION

To solve the problem, a circumstance information management system according to the present invention uses the following two aspects.

In a first aspect, information about circumstances surrounding each item in particular locations is obtained from information such as temperature or humidity measured from time to time with circumstance information obtaining apparatuses such as temperature sensors or humidity sensors installed in fixed locations such as a warehouse, factory, and truck beds (a circumstance history) and from information obtained with movement information obtaining apparatuses that detect the movement of each item (a movement history). In particular, movement information obtaining apparatuses are placed at the entrance to and exit from a place such as a warehouse where the circumstance history is to be obtained with circumstance information obtaining apparatuses and the relationships between the place and the circumstance information obtaining apparatuses are managed as circumstance-movement association master. Recorded in the circumstance history are identifications of the circumstance information obtaining apparatuses, circumstance information measurement dates and time, and measured values of circumstance information. Recorded in the movement history are passage locations, passage dates and times and identifications of items such as item IDs. To obtain a circumstance history of a particular item in a particular place, the dates and times at which the item ID associated with the item entered and left the place are obtained from the movement history and values measured with the circumstance information obtaining apparatuses during the period between the passage dates and times are obtained.

Furthermore, monitor conditions such as the upper and lower limits of measured values are set for each individual item or each type of item and an item that meets a monitor condition is retrieved from the circumstance history and the movement history as follows. First, the circumstance history is searched for a measured value by using the monitor condition. If there is a measured value that meets the monitor condition, the relevant circumstance information obtaining apparatus and the measurement date and time are obtained from the circumstance history. Then, the place associated with the circumstance information obtaining apparatus is retrieved from a circumstance-movement association master and determination is made from the movement history as to whether there is a history record that indicates that the item to which the monitor condition is applied passed through the place at the measurement date and time. If the item stays in the place, notification is provided that there is an item that meets the monitor condition.

In a second aspect, a circumstance information obtaining apparatus is attached to each individual item or an object such as a container that moves along with an item and a circumstance history for each item is traced. The circumstance information obtaining apparatus is reusable.

In particular, identification information such as an item ID of an item, a circumstance information obtaining apparatus attached to the item, the attachment date and time, and the removal date and time are managed using a circumstance-item association master. To obtain a circumstance history of a particular item, the identification of the circumstance information obtaining apparatus attached to the item, the attachment date and time, the removal date and time are obtained from a circumstance-item association master, and a measured value associated with the circumstance information obtaining apparatus and measured during the period between the attachment date and time and the removal date and time is obtained from the circumstance history.

According to the first aspect of the present invention, values measured with circumstance information obtaining apparatuses such as temperature sensors or humidity sensors that are placed in particular places such as a warehouse, a factory, or truck beds are used to obtain a circumstance history such as a temperature history or a humidity history of each item. Therefore only a small number of circumstance information obtaining apparatuses have to be provided and an apparatus does not have to be attached to each item. Accordingly, information about circumstances surrounding items can be managed at low costs. According to the second aspect of the present invention, a circumstance history of each item can be obtained even if a circumstance information obtaining apparatus attached to each item or a container that moves along with each item is reused.

### BRIEF DESCRIPTION OF THE DRAWINGS

FIG. 1 shows an overall configuration of the circumstance information management system according to an embodiment of the present invention;

FIG. 2 shows an example in which the circumstance information management system according to an embodiment of the present invention is applied to products distribution operations;

FIG. 3 shows a circumstance-movement association master according to an embodiment of the present invention;

FIG. 4 shows a circumstance-item association master according to an embodiment of the present invention;

FIG. 5 shows a circumstance monitor condition master according to an embodiment of the present invention;

FIG. 6 shows an item type master according to an embodiment of the present invention;

FIG. 7 shows a circumstance history according to an embodiment of the present invention;

FIG. 8 shows a movement history according to an embodiment of the present invention;

FIG. 9 shows a process flow of a circumstance monitoring program according to an embodiment of the present invention;

FIG. 10 shows an exemplary circumstance abnormality warning screen according to an embodiment of the present invention;

FIG. 11 shows an exemplary search screen according to an embodiment of the present invention;

FIG. 12 shows an exemplary search result screen according to an embodiment of the present invention;

FIG. 13 shows a process flow of a circumstance history search program according to an embodiment of the present invention;

FIG. 14 shows an example in which the circumstance information management system according to the present invention is applied to products distribution operations;

FIG. 15 shows a process flow of a circumstance monitoring program according to an embodiment of the present invention;

FIG. 16 shows an exemplary circumstance abnormality warning screen according to an embodiment of the present invention;

FIG. 17 shows an exemplary search screen according to an embodiment of the present invention;

FIG. 18 shows an exemplary search result screen according to an embodiment of the present invention;

FIG. 19 shows a process flow of a circumstance history search program according to an embodiment of the present invention; and

FIG. 20 shows an overall configuration of a circumstance information management system according to an embodiment of the present invention.

### DESCRIPTION OF THE PREFERRED EMBODIMENTS

A first embodiment of the present invention will be described with reference to the accompanying drawings.

### First Embodiment

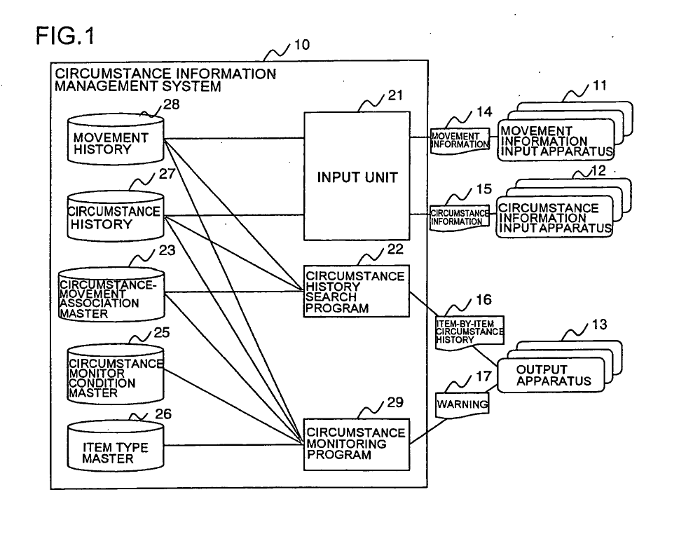

FIG. 1 shows a system configuration of a circumstance information management system according to a first embodiment of the present invention.

Movement information input apparatuses 11 are devices such as an electronic tag reader, a barcode reader, and a keyboard for generating movement information 14 based on the movement of products and inputting it in the circumstance information management system 10. An input unit 21 receives movement information 14 and stores it in a movement history 28.

The movement information 14 is information concerning the shipment and arrival of products, storage of products in and shipping from a warehouse, and movement of products within a factory or warehouse. The movement information 14 includes item IDs, which are identifiers of products, dates and times on which products moved, such as shipping dates and times, arrival dates and times, dates and times at which products were stored in or shipped from a warehouse, location IDs which indicate locations from or to which products have been moved or through which products have passed, and information indicating the state of movement such as “arrival” or “shipping”.

Circumstance information input apparatuses 12 are devices such as a temperature sensor or a keyboard for measuring circumstance data such as temperature, humidity, pressure, pH, acceleration, odor, or the concentration of a particular substance such as carbon dioxide or carbon monoxide, generating circumstance information 15 from the data, and imputing it in the circumstance information management system 10. The input unit 21 receives the circumstance information 15 and stores it in a circumstance history 27.

Circumstance information 15 includes measured values concerning circumstances such as temperature, the measurement dates and times, and information about measuring apparatuses.

A circumstance-movement association master 23 defines locations in which circumstance information measuring apparatuses measure circumstance data. In particular, each location where circumstance data is measured is defined with a location ID indicating movement into the location, the state of the movement, and a location ID indicating movement from the location and the state of the movement. If just location IDs are enough for identifying the history of movement to and from locations, the states of movements are unnecessary.

A circumstance history search program 22 generates a circumstance history 16 of each item of products, which indicates a history of circumstances associated with a particular item ID from a movement history 28, circumstance history 27, and the circumstance-movement association master 23 and outputs it to an output apparatus 13 such as a printer or a display.

A circumstance monitor condition master 25 monitors the circumstance information 15 or the circumstance history 27 and defines conditions for detecting abnormalities in circumstances surrounding each item of products or each type of products defined in an item type master 26, which will be described later. The conditions to be monitored may include those defining upper and lower limits of a circumstance value and the amount of a variation in a circumstance value per unit time.

The item type master 26 defines the types of product classified by product name or article code, or the types of product classified by storage condition such as “chilled food” or “frozen food”. The type is defined with a combination of an item type and an item ID of an item that belongs to the item type.

A circumstance monitoring program 29 monitors the circumstance history 27 or circumstance information 15 in accordance with circumstance monitor conditions for the circumstance history for each item type defined in the circumstance monitor condition master 25, identifies an item of products that meets a condition from the item type master 26 which defines which item belongs to which item type and from the movement history 28, and outputs a warning 17 including information such as the circumstance monitor condition, the item that meets the circumstance monitor condition, the location, and the date and time to an output apparatus 13. Processes performed by the circumstance history search program 22 and circumstance monitoring program 29, which will be described later, may be stored in a medium that can be read by computer such as personal computers and may be read from the medium and executed as needed.

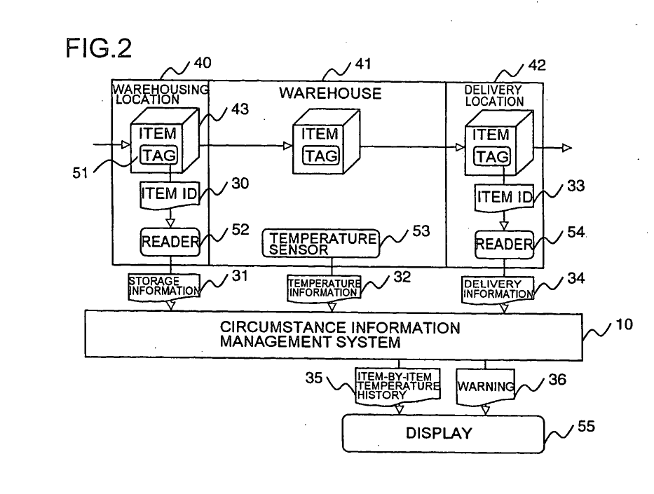

Referring to FIG. 2, processes in the circumstance information management system according to the first embodiment will be described with respect to an example in which the processes are applied to products distribution operations in which products are stored in a warehouse through a products receipt location and are shipped from the warehouse through a shipping preparation location after a certain period of time.

While the embodiment will be described with respect to temperature, any other data such as humidity, pressure, pH, acceleration, or odor may be used. It may be the concentration of a particular substance such as carbon dioxide or carbon monoxide. In such a case, the circumstance information input apparatuses may be humidity sensors, pressure sensors, pH sensors, acceleration sensors, odor sensors, gas concentration sensors, or the like.

It is assumed that items of products 43, each equipped with a tag 51 containing an item ID 30 of the item 43, are moving. The tag 51 may be a machine-readable tag such as an electronic tag or a barcode, or may be a paper tag containing an item ID 30 visible to the human eye.

When an item 43 arrives at the warehousing location that is the entrance to a warehouse 41, an item ID 30 of the item 43 is read by a reader 52, which is equivalent to a movement information input apparatus 11 in FIG. 1, and is then stored in the warehouse 41. The reader 52 reads the item ID recorded on the tag 51 and inputs or sends it to the circumstance information management system 10. Depending on the type of the tag 51, a human operator, instead of an electric tag reader or barcode reader, may read the item ID written on the tag 51 and input it through a keyboard.

The reader 52 inputs, into the circumstance information management system 10, storage information 31, which is equivalent to the movement information 14 in FIG. 1, including the item ID 30, the read date and time as the movement date and time, a reader ID of the reader 52 as the movement location ID, and “Storage” as the movement state.

When receiving the storage information 31, the circumstance information management system 10 stores it in a movement history 28.

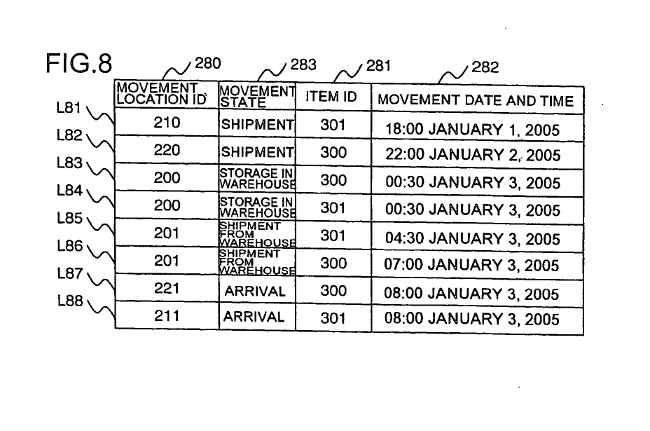

FIG. 8 shows an example of the movement history 28. For example, the record denoted by reference numeral L84 indicates that on storage of an item with the item ID “301” in the warehouse 41, a reader with the reader ID “200” read and stored the reader ID at the date and time “00:30 Jan. 3, 2005”.

The temperature in the warehouse 41 is measured with a temperature sensor 53, which is equivalent to a circumstance information input apparatus 12 in FIG. 1, at regular time intervals regardless of the storage and shipment of items 43. The measurement may be conducted every one second or every one hour. If the temperature measured with the temperature sensor at “01:00 Jan. 3, 2005” is “−22° C.”, the temperature sensor 53 sends the measured temperature “−22° C.”, the measurement date and time “01:00 Jan. 3, 2005”, and the temperature sensor ID of the measuring apparatus to the circumstance information management system 10 as temperature information 32, which is equivalent to the circumstance information 15 in FIG. 1.

When receiving the temperature information 32, the circumstance information management system 10 stores it in a circumstance history 27.

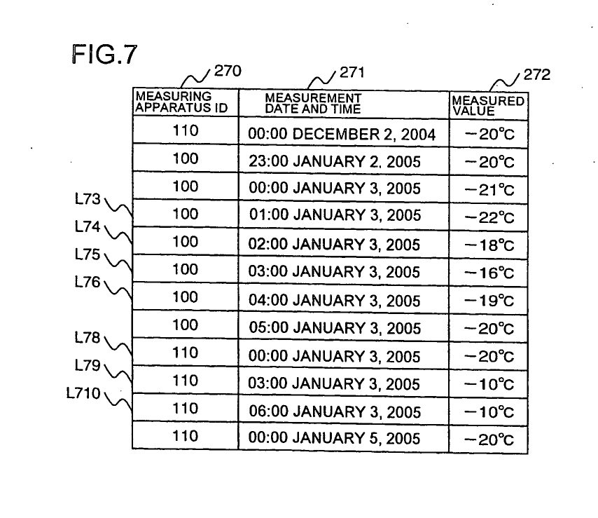

FIG. 7 shows an example of the circumstance history 27. Record L73 in FIG. 7 represents temperature information 32 obtained with a sensor ID “100” in the example described.

When an item 43 is taken out of the warehouse 41 and moved to the shipping preparation location 42, a reader 54 reads the item ID 33 and inputs it into the circumstance information management system 10 together with the reading date and time, the ID of the reader 54 which is the movement location ID, and the state of movement “Shipment”, as warehouse shipping information 34, in a manner similar to the storage to the warehouse described above.

The record denoted by L85 in FIG. 8 indicates that on shipment of an item with the item number ID “301” from the warehouse, a reader with the reader ID “201” has read and stored the item ID at “04:30 Jan. 3, 2005”, as with the example of storage to the warehouse.

In this way, information is recorded in the movement history 28 which is a record concerning the movement of products and the circumstance history 27 which is a circumstance measurement history.

The circumstance-movement association master 23, circumstance monitor condition master 25, and item type master 26 in the first embodiment will be described below.

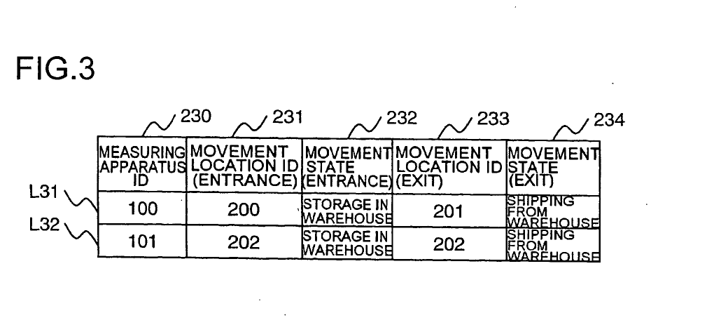

FIG. 3 shows an example of the circumstance-movement association master 23. Data denoted by reference numeral L31 defines that the circumstances surrounding an item with the movement location ID “200” and the movement state “Storage in the warehouse” and an item with the movement location ID “201” and the movement state “Shipment from the warehouse” are measured with a circumstance information measuring apparatus with the measuring apparatus ID “100” during their movement. Data denoted by reference numeral L32 defines that the circumstances surrounding an item with the movement location ID “202” and the movement state “Storage in the warehouse” and an item with the movement location ID “202” and the movement state “Shipment from the warehouse” are measured with a circumstance information measuring apparatus with the measuring apparatus ID “101”.

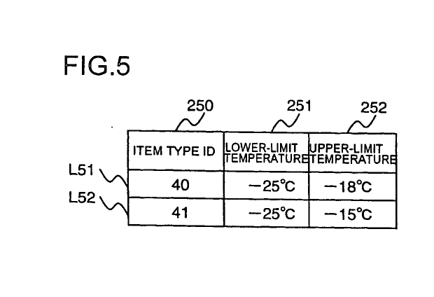

FIG. 5 shows an example of the circumstance condition master 26. Data denoted by reference numeral L51 defines that a condition should be detected in which a measured value in the circumstance information about or the circumstance history of an item with the item type ID “40” is out of the range between an upper-limit temperature of “−18° C.” and a lower-limit temperature of “−25° C.”. Data denoted by reference numeral L52 defines that a condition should be detected in which a measured value in the circumstance information about or the circumstance history of an item with the item type ID “41” is out of the range between a upper-limit temperature of “−15° C.” and a lower-limit temperature of “−25° C.”.

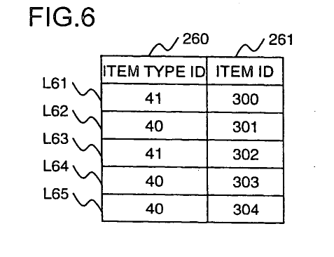

FIG. 6 shows an example of the item type master 26. Data denoted by reference numerals L62, L64, and L65 define that items with the item IDs “301”, “302”, and “303” belong to a item type with item type ID “40” respectively. Data denoted by reference numerals L61 and L63 define that items with the item IDs “302” and “303” belong to a item type with the item type ID “41” respectively.

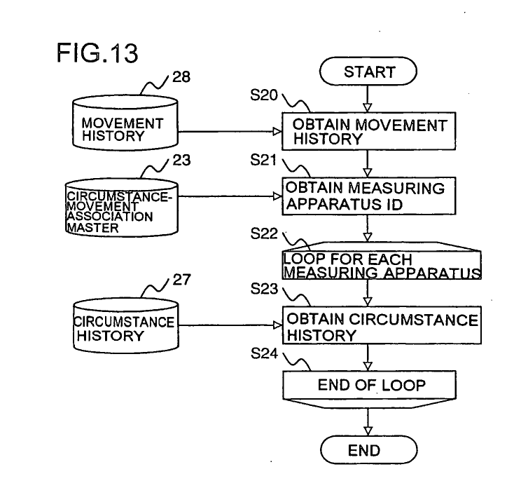

A process of the environment history search program 22 will be described with reference to a process flow shown in FIG. 13.

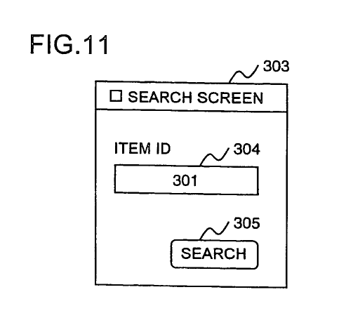

At step S20 in FIG. 13, a movement history record of a particular item is obtained from the movement history 28 shown in FIG. 8. The particular item is specified by entering an item ID, “301” in an item ID entry field 304 in a search screen 303 shown in FIG. 11, for example, and then pressing a search button 305. When the item ID “301” is entered as in the example shown, history records L81, L84, L85, and L88 in FIG. 8 with item ID 281 “300” are obtained as the result of the search.

Then, at step S21, the movement history 28 is searched for time at which the item was at a place such as a warehouse 41 where a temperature sensor is installed (FIG. 3 shows an example of the circumstance-movement association master.)

In particular, the sets of the movement location IDs 280 and a movement states 283 obtained from the movement history at step S20 are searched through for a match with a set of a movement location ID (entrance) 231 and a movement state (entrance) 232 in the circumstance-movement association master 23 shown in FIG. 3 and a match with a set of a movement location ID (exit) 233 and a movement state (exit) 234, and the measuring apparatus IDs and the durations during which the item was in those locations are obtained.

In the example described, the set of the movement ID 280 and the movement state 283 indicated by reference numeral L84 in FIG. 8 matches the set of the movement location ID (entrance) 231 and the movement state (entrance) 232 indicated by reference numeral L31 in FIG. 3; the set of movement location ID 280 and the movement state 283 indicated by L85 matches the set of the movement location ID (exit) 233 and the movement state (exit) 234 indicated by L31. Therefore, the period from the movement date and time 282 “00:30 Jan. 3, 2005” indicated by L84 to the movement date and time “04:30 Jan. 3, 2005” indicated by L85 is obtained as the duration during which the item was at the location at which the measuring apparatus with the measuring apparatus ID 230 “100” indicated by L31 is installed.

Then, steps S22 to S24 are repeated for each measuring apparatus ID obtained at step S21. Because only one measuring apparatus ID, “100”, has been obtained in the example described, steps 22 to S24 are performed once. At step S23, a measured value that matches the measuring apparatus ID obtained at step S21 and was measured during the duration is obtained from the circumstance history 27, and the temperature history 35 for each item which consists of the measuring apparatus information (temperature sensor information in this embodiment) and is equivalent to the item-by-item circumstance history 16 in FIG. 1 is sent to and displayed on a display 55 which is equivalent to an output apparatus 13.

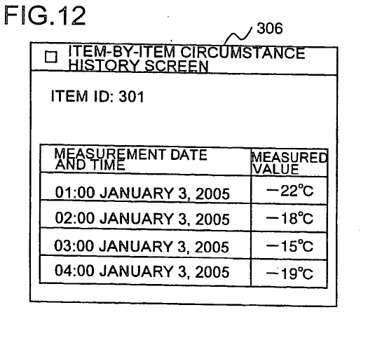

In the example described, obtained from the circumstance history 27 shown FIG. 7 are the measured values 272 in history records L73, L74, L75, and L76 with the measuring apparatus ID “100” during the period from “00:30 Jan. 3, 2005” to “04:30 Jan. 3, 2005” indicated by the measurement time and date 271. FIG. 12 shows an item-by-item circumstance history screen 306 displayed on the display 55.

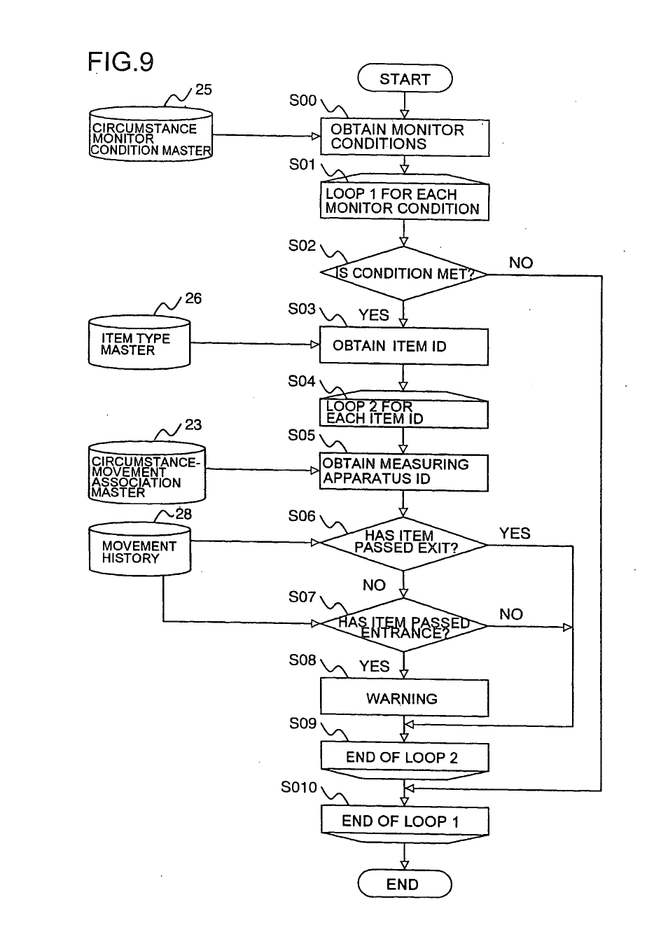

A process of the circumstance monitoring program 29 will be described with reference to the process flow in FIG. 9. The process may be performed when temperature information 32 is registered in the circumstance information management system 10 or may be performed later for each row of the circumstance history 27. The process will be described here on the assumption that the measuring apparatus ID “100”, the measurement date and time “03:00 Jan. 3, 2005”, and the measured value “−16° C.” have been inputted as the temperature information 32.

First, all circumstance monitor conditions are obtained from the circumstance monitor condition master 25 at step S00.

FIG. 5 shows an example of the circumstance condition master 25. As shown, the circumstance condition master 25 includes an item type ID 250 indicating the type of an item and the lower-limit temperature 251 and upper-limit temperature 252 of a measured value for the item to be monitored. Steps S01 to S010 are repeated for each circumstance monitor condition read at step S00. At step S02, determination is made as to whether the measured value in the temperature information 32 meets a circumstance monitor condition. If it does, the process proceeds to step S03. It is determined here that the value meets a condition if it is less than the lower-limit temperature 251 mentioned above or exceeds the upper-limit temperature 255. In this example, determination is made as to whether the measured value “−16° C.” meets any of the conditions denoted by reference numerals 51 and L52. Because the measured value “−16° C.” exceeds the upper-limit temperature “−18° C.” in the condition L51, it is determined that the measured value meets the circumstance monitor condition L51, and the process proceeds to step S03.

At step S03, an item that matches the item type ID 250 in the circumstance monitor condition met is retrieved from the item type master 26. FIG. 6 shows an example of the item type master 26. The item type master 26 consists of item type ID 260 indicating the types of item and item IDs 261 that belong to the types. In this example, item IDs 261 that match the item type ID “40” contained in the circumstance monitor condition L51 are searched for, and item IDs “301”, “303”, and “304” are obtained from the data L62, L64, and L65.

Then, steps S04 to S09 are repeated for each item ID obtained at step S03 to determine from the movement history 28 and the circumstance-movement association master 23 whether the item is at a location where the temperature sensor that measured the temperature that meets the circumstance monitor condition is placed. At step S05, a movement location ID (entrance) 231, movement state (entrance) 232, a movement location ID (exit) 233, and movement state (exit) 234 that match the measuring apparatus ID in the temperature information 32 are obtained from the circumstance-movement association master 26 shown in FIG. 3. In this example, the movement ID (entrance) 231 “200” and the movement state (entrance) 232 “Storage in warehouse” and the movement ID (exit) 233 “201” and the movement state (exit) 234 “Shipment from warehouse” in L31 that correspond to the measuring ID “100” of the temperature sensor that measured the temperature are obtained.

At step S06, determination is made from the movement history 28 shown in FIG. 8 as to whether the item with the item ID obtained at step S03 has passed the location indicted by the movement location ID (exit) 233 and the movement state (exit) 234 obtained at step S05. If not, the process proceeds to step S07.

Here, it is also determined that the item has not passed the exit if there is not a record of passage through the exit in the movement history 28. In this example, the movement date and time 282 “04:30 Jan. 3, 2005” in record L85 with the item ID “301”, the movement location ID 280 “201”, and the movement state 283 “Shipment from the warehouse” is later than the temperature measurement date and time “03:00 Jan. 3, 2005”. Therefore it is determined that the item had not passed the exit at the temperature measurement time, and consequently the process proceeds to step S07.

At step S07, determination is made from the movement history 28 shown in FIG. 8 as to whether the item with the item ID obtained at step S03 has passed the location with the movement location ID (entrance) 231 and the movement state (entrance) 232 obtained at step S05. If so, the process proceeds to step S08.

In this example, the movement date and time 282 “00:30 Jan. 3, 2005” in record L84 with the item ID “301”, the movement ID 280 “200”, and the movement state 283 “Storage in the warehouse” is earlier than the temperature measurement date and time “03:00 Jan. 3, 2005”. Therefore it is determined that the item has passed the entrance at the temperature measurement time, and consequently the process proceeds to step S08.

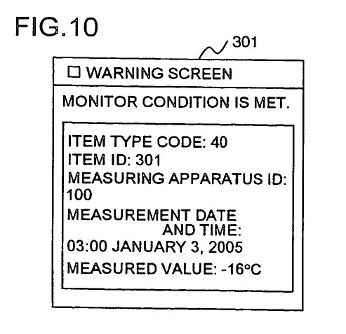

At step S08, a warning 36, which is equivalent to the warning 17 shown in FIG. 1, indicating that the item obtained through the process meets the circumstance monitoring information is sent to and displayed on the display 55, which is equivalent to the output apparatus 13. FIG. 10 shows an exemplary warning screen 301.

In this example, steps S04 to S09 are repeated for data L64 and L65. Because the movement histories of the items with the item ID 261 “303” and “304” in data L64 and L65 are not contained in the movement history 28 shown in FIG. 8, it is determined at step S07 that the items have not passed the entrance, and the process will end. Then, steps S01 to S010 are repeated for the circumstance monitor condition L52. It is determined at step S02 that the measured temperature “−16° C.” is not beyond the lower-limit temperature “−25° C.” and the upper-limit temperature “−15° C.” in the conditions L52 and therefore the process will end.

### Second Embodiment

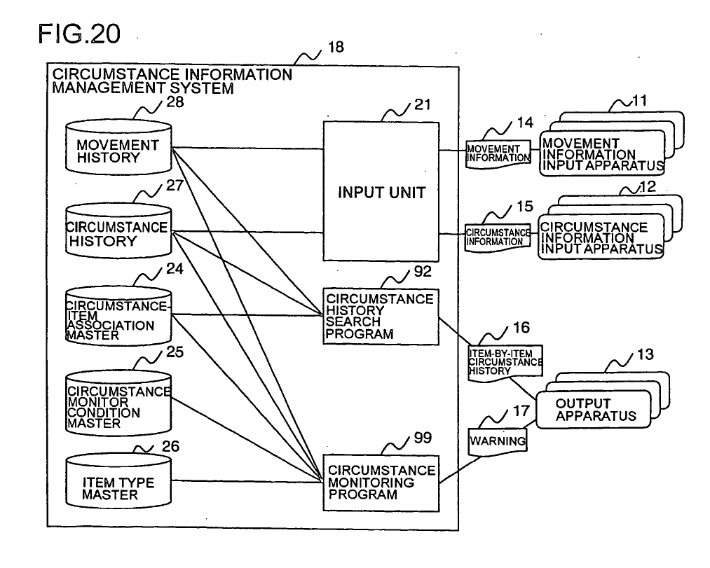

A second embodiment of the present invention will be described with respect to the accompanying drawings. FIG. 20 shows a system configuration of a circumstance information management system according to the second embodiment.

Referring to FIG. 20, an overall configuration of the circumstance information management system 18 will be described.

The movement information input apparatuses 11, movement information 14, circumstance information input apparatuses, output apparatuses 13, circumstance information 15, item-by-item circumstance history 16, warning 17, input unit 21, movement history 28, circumstance history 27, circumstance monitor condition master 25, and item type master 27 are apparatuses or information similar to those of the circumstance information management system 10 shown in FIG. 1 in the first embodiment. A circumstance-item association master 24 defines each of circumstance information measuring apparatuses attached to items or objects such as boxes that move together with items, as a set of measuring apparatus ID that is an identifier of a circumstance information input apparatus and an item ID that is an identifier of an item to be measured with the circumstance information measuring apparatus. If a circumstance information input apparatus is reused, the date and time at which the circumstance information measuring apparatus was attached to the item and the date and time at which the circumstance information input apparatus was removed from the item are recorded in addition to the measuring apparatus ID and the item ID.

A circumstance history search program 92 generates item-by-item circumstance history 16, which is a history of circumstances surrounding a particular item ID, from the movement history 28, circumstance history 27, and circumstance-item association master 24 and outputs it to an output apparatus 13 such as a printer or a display.

A circumstance monitoring program 99 monitors the circumstance history 27 or the circumstance information 15 in accordance with circumstance monitor conditions for each type of item that is defined in the circumstance monitor condition master 25, identifies an item that meets a condition from a item type master 26 that defines which item belongs to which type of item and from the movement history 28, and outputs a warning 17 including a circumstance monitor condition, an item that meets the circumstance monitor condition, and information such as the location, and date and time to an output apparatus 13.

Processes of the circumstance history search program 92 and the circumstance monitoring program 99, which will be described later, may be stored as programs in a computer-readable medium that can be read by a computer such as a personal computer and may be read from the recording medium and executed as needed.

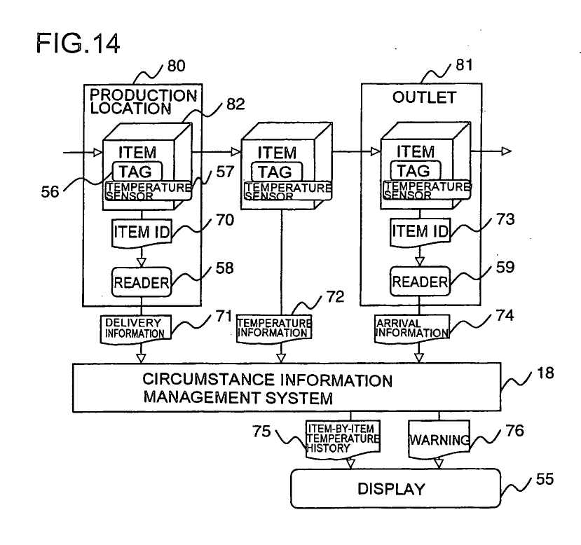

Referring to FIG. 14, processes in the circumstance information management system according to the second embodiment will be described with respect to an example in which the processes are applied to products distribution operations in which products are shipped from the production location, transported by a vehicle such as a truck, and then delivered to an outlet. Storage to and shipment from a warehouse described with reference to FIG. 2 in the first embodiment may also be performed between the shipment from the production location and arrival at the outlet.

While the second embodiment will be described with respect to temperature as circumstance information, it may be other circumstance information such as humidity, pressure, pH, acceleration, or odor. It may be the concentration of a particular substance such as carbon dioxide or carbon monoxide. In such a case, the circumstance information input apparatuses may be temperature sensors, pressure sensors, pH sensors, acceleration sensors, odor sensors, gas concentration sensors, or the like.

It is assumed that each item 82 is equipped with a tag 56 containing an item ID 70 of the item 82 and a temperature sensor 57 that measures the temperature of the item 82 while moving. The tag 56 may be a machine-readable tag such as an electronic tag or a barcode, or may be a paper tag containing an item ID 70 visible to the human eye.

When an item 82 is shipped from the production location 80, the item ID 70 is read by a reader 58, which is equivalent to a movement information input apparatus 11 shown in FIG. 20. The reader 58 reads the item ID recorded on the tag 56 and inputs or sends it to the circumstance information management system 18. The reader 58 may be an electronic tag reader or a barcode reader, depending on the type of the tag 56. Also, a human operator may read the item ID written on the tag 56 and input it through a keyboard.

The reader 58 inputs reading dates and times as movement dates and times, a reader ID of the reader 58 as a movement location ID, and “Shipment” as the movement state in the circumstance information management system 18 as shipment information 71, which is equivalent to the movement information 14 in FIG. 20. When receiving the shipment information 71, the circumstance information management system 18 stores it in a movement history 28.

FIG. 8 shows an example of the movement history 28. For example, the record denoted by reference numeral L82 indicates that a reader with the reader ID “220” has scanned an item with the item ID “300” and stored information at the date and time “22:00 Jan. 2, 2005”.

When the item 82 arrives at an outlet 81, an item ID 73 is read by a reader 59 and is input in the circumstance information management system 18, as in the shipment from the production location 80, along with the read date and time, the ID of the reader 58 which is a movement location ID, and the movement state “Arrival” as arrival information 74 equivalent to the movement information 14 in FIG. 20. Record L87 in FIG. 8 represents an example in which an item with the item ID “300” arrived at the outlet 81 was scanned and stored by a reader with the reader ID “221” at “08:00 Jan. 3, 2005”.

The temperature of the item 82 is measured at regular time intervals with a temperature sensor 57, which is equivalent to a circumstance information input apparatus 12 shown in FIG. 20, attached to the item 82 or an object such as a box that moves together with the item 82. The measurement may be performed every one second or every one hour. If the temperature sensor 57 measures a temperature of “−20° C.” at “00:00 Jan. 3, 2005”, the measured temperature “−20° C.”, the measurement date and time “00:00 Jan. 3, 2005” and a temperature sensor ID which is the identifier of the measuring apparatus are sent to the circumstance information management system 18 as temperature information 72 equivalent to the circumstance information 15 in FIG. 20. The temperature information 72 may be sent each time the temperature is measured or at predetermined time intervals through a mobile phone or satellite communication, or may be stored by the temperature sensor 57, read by a reader 59 at the outlet 81 along with the item ID 73, and sent to the circumstance information management system 18 together with arrival information 74.

When receiving the temperature information 72, the circumstance information management system 18 stores it in a circumstance history 27.

FIG. 7 shows an example of the circumstance history 27. Reference numeral L78 in FIG. 7 denotes temperature information 72 obtained by the temperature sensor with the temperature sensor ID “110” in the example described.

Thus, the information is recorded in the movement history 28 which records the movement of items and in the circumstance history 27 which is a history of measurements of circumstances.

The circumstance-item association master 24 according to the second embodiment will be described below. The circumstance monitor condition master 25 and the item type master 26 are the same as those in the first embodiment and therefore the description of which will be omitted.

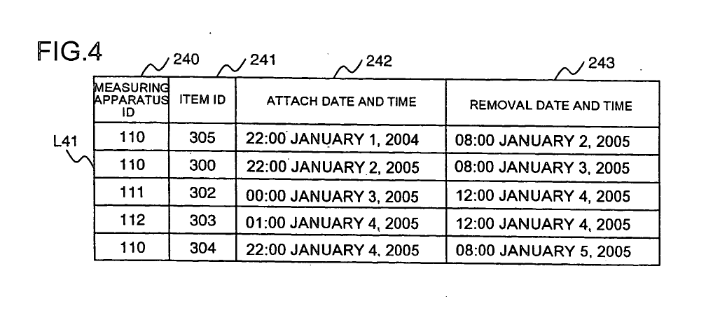

FIG. 4 shows an example of the circumstance-item association master 24. For example, data L41 defines that a circumstance information input apparatus with the measuring apparatus ID “110” is kept attached to an item with the item ID “300” or an object close to the item such as a box in the period between the attachment date and time “22:00 Jan. 2, 2005” and the removal date “08:00 Jan. 3, 2005” and the circumstances surrounding the item are measured with the circumstance information input apparatus during the period.

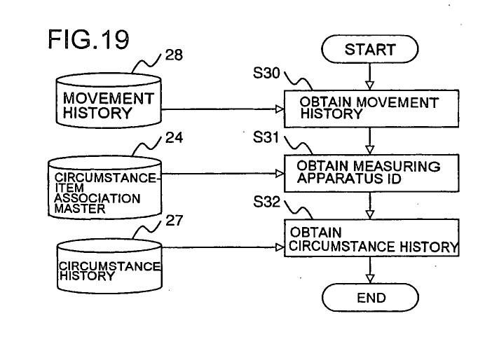

Referring to the process flow shown in FIG. 19, a process of the circumstance history search program 92 will be described.

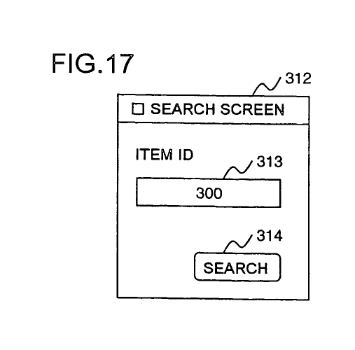

At step S30 in FIG. 19, the history of the movement of a particular item is retrieved from a movement history shown in FIG. 8. The item is specified by inputting the item ID “300” of the item in an item ID entry field 313 in a screen 312 shown in FIG. 17, for example, and pressing a search button 314. When the item ID “300” is inputted as shown in the example, data L82, L83, L86, and L87 in FIG. 8 are retrieved as a result of the search.

Then, at step S31, the circumstance-item association master 24 is searched to retrieve information indicating the circumstance information input apparatus attached to the item, its attachment date and time, and its removal date and time. Because the item ID is “300” in the example described, the measuring apparatus ID “110”, the attachment date and time “22:00 Jan. 2, 2005”, and the removal date and time “08:00 Jan. 3, 2005” are obtained from data L41 with item ID “300” in the circumstance-item association master 24 shown in FIG. 4.

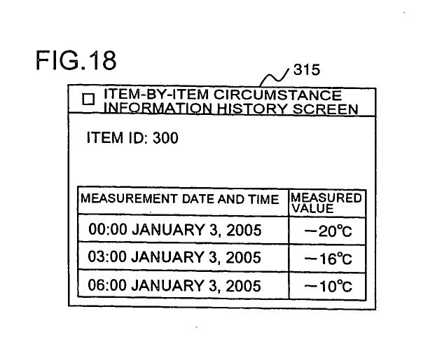

Then, at step S32, circumstance values measured during the period between the date and time at which the circumstance information input apparatus identified at step S31 was attached and the date and time at which it was removed are obtained from the circumstance history 27 and an item-by-item temperature history 75, which includes information indicating a measuring apparatus (a temperature sensor in this example) and is equivalent to the item-by-item circumstance history 16 in FIG. 20, is sent to and displayed on a display 55, which is equivalent to an output apparatus 13. In the example described, data L78, L79, and L710 that have the measuring ID “110” and measurement dates and times between the attachment date and time “22:00 Jan. 2, 2005” and the removal date “08:00 Jan. 3, 2005” are retrieved from the circumstance history 27 shown in FIG. 7. FIG. 18 shows an exemplary item-by-item circumstance history screen 315 displayed on the display 55.

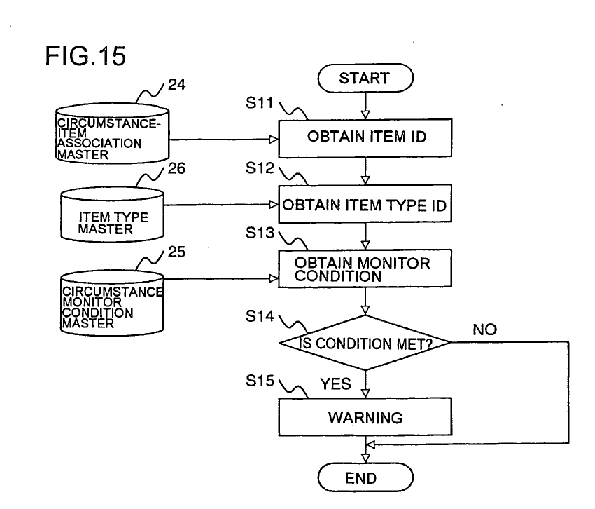

Referring to the process flow shown in FIG. 15, a process of the circumstance monitoring program 99 will be described. The process may be performed when temperature information 72 is recorded in the circumstance information management system 18 or may be performed later for each row in the circumstance history 27. The process will be described here on the assumption that the measuring apparatus ID “110”, the measurement date and time “03:00 Jan. 3, 2005”, and the measured value “−10° C.” have been inputted as temperature information 72.

First, at step S11, the item ID of an item associated with the measuring apparatus ID inputted as the temperature information 72 is retrieved from the circumstance-item association master 24. In the example described, the item ID 241 “300” is obtained from data L41 in the circumstance-item association master 24 shown in FIG. 4 that matches the conditions that the measuring apparatus ID 240 matches the measuring apparatus ID “110” in the temperature information 72 and that the measurement date and time “03:00 Jan. 3, 2005” in the temperature information 72 is between the attachment date and time 242 and the removal date and time 243. If a removal date and time 243 is not registered, it may be determined that the apparatus has not yet been removed and that the measurement date and time in the temperature information 72 is later than the attachment date and time 242.

At step S12, the item type to which the item with the item ID obtained at step S11 belongs to is obtained from the item type master 26. In the example described, the item IDs 261 in the item type master 26 shown in FIG. 6 is searched through for the item ID “300” obtained at step S11 and the item type ID “41” is obtained from data L61 that meets the search criteria.

At step S13, a circumstance monitor condition for the item type obtained at step S12 is retrieved from the circumstance monitor condition master 25. In the example described, the item type IDs 250 in the circumstance monitor condition master 25 shown in FIG. 5 are searched through for the item type ID “41” obtained at step S12 and the condition L52 that matches the search criteria is obtained.

At step S14, the measured value in the temperature information 72 inputted is checked to determine whether it meets the circumstance monitor condition obtained at step S13. If it does, the process proceeds to step S15; otherwise the process will end. In the example described, determination is made as to whether the measured value “−10° C.” is in the range between an upper-limit temperature of “−15° C.” and a lower-limit temperature of “−25° C.” in the circumstance monitor condition L52. Because the measured temperature “−10° C.” is higher than the upper-limit temperature “−15° C.”, the process proceeds to step S15.

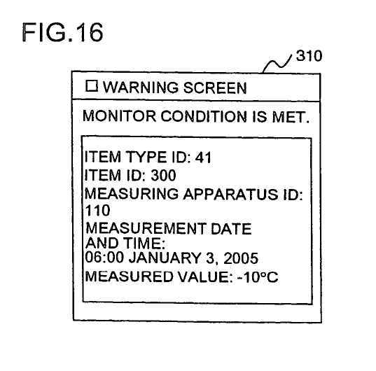

At step S15, a warning 76, which is equivalent to the warning 17 shown in FIG. 1, indicating that the item obtained as a result of the process described above meets the circumstance monitor condition is sent to and displayed on the display 55, which is equivalent to an output apparatus 13. FIG. 16 shows an exemplary warning screen 310 displayed on the display 55.

The present invention can be used in the distribution of any items such as food distribution in which the management of circumstance data such as temperature is important. Furthermore, the present invention can also be used to associate circumstances in rooms in a factory with items being manufactured and can find a wide range of applications, in addition to product distribution.

Having described a preferred embodiment of the invention with reference to the accompanying drawings, it is to be understood that the invention is not limited to the embodiments and that various changes and modifications could be effected therein by one skilled in the art without departing from the spirit or scope of the invention as defined in the appended claims.

What is claimed is:

1. A circumstance information management system that obtains and manages circumstance information in a particular location of items that are moving,
the circumstance information management system having:
a movement history having at least an item identifier identifying an item, a location identifier identifying a location through which the item moved or passed, and information indicating movement dates and times at which the item moved or passed,
a circumstance history having at least a measuring apparatus identifier identifying a measuring apparatus that measures circumstance information about an item, a measured value measured with the measuring apparatus, and information about the date and time of the measurement, and
a circumstance-movement association master having a doorway identifier identifying a doorway to a particular location at which the measuring apparatus is placed and a measuring apparatus identifier identifying the measuring apparatus placed at the location,
the circumstance information management system comprising:
in order to obtain circumstance information about a particular item in a particular location,
means for obtaining from the circumstance-movement association master a doorway identifier associated with a measuring apparatus that obtains the circumstance information;
means for obtaining movement dates and times at which the item moved or passed through a location that matches the doorway identifier from the movement history and determining the movement dates and times as information indicating the period during which the item stayed at the location where the measuring apparatus that obtains circumstance information is placed; and
means for obtaining from the circumstance history a measured value measured with the measuring apparatus during the period.

2. The circumstance information management system according to claim 1, further comprising:
means for holding permissible limits of a measured value for each item or each type of item measured with a measuring apparatus;
means for obtaining a doorway identifier associated with the measuring apparatus from the circumstance-movement association master if a measured value that is out of the permissible limits is obtained with a measuring apparatus in a particular location;
means for obtaining an item that stays in a location that matches the doorway identifier from the movement history; and
means for providing a warning if the item matches an item or a type of item associated with the permissible limits.

3. A circumstance information management system that obtains and manages circumstance information in a particular location of items that are moving,
the circumstance information management system having:
a movement history having at least an item identifier identifying the item, a location identifier identifying a location through which the item moved or passed, and information indicating movement dates and times at which the item moved or passed,
a circumstance history having at least a measuring apparatus identifier identifying a measuring apparatus that measures circumstance information about an item, a measured value measured with the measuring apparatus, and information about the date and time of the measurement, and
a circumstance-item association master having at least a measuring apparatus identifier identifying a measuring apparatus that measures circumstance information about an item, an item identifier of an item to which the measuring apparatus is attached, and a attachment period during which the measuring apparatus is attached to the item,
the circumstance information management system comprising:
in order to obtain circumstance information about a particular item in a particular location,
means for obtaining from the movement history a period during which the item for which the circumstance information is to be obtained stayed at a particular location through which the item moved or passed;
means for obtaining an measuring apparatus identifier of a measuring apparatus associated with the item from the circumstance-item association master; and
means for obtaining from the circumstance history a measured value measured with a measuring apparatus that matches the measuring identifier apparatus during the period.

4. The circumstance information management system according to claim 3, further comprising:
means for holding permissible limits of a measured value for each item or each type of item measured with a measuring apparatus;
means for obtaining an item identifier of an item associated with a particular measuring apparatus from the circumstance-item association master if a measured value that is out of the permissible limits is obtained with the particular measuring apparatus; and
means for providing a warning if the item matches an item or type of item that is associated with the permissible limits.

5. An information management method for a circumstance information management system that obtains and manages circumstance information in a particular location of items that are moving, the circumstance information management system having a movement history having at least an item identifier identifying an item, a location identifier identifying a location through which the item moved or passed, and information indicating movement dates and times at which the item moved or passed; a circumstance history having at least a measuring apparatus identifier identifying a measuring apparatus that measures circumstance information about an item, a measured value measured with the measuring apparatus, and information about the date and time of the measurement; and a circumstance-movement association master having a doorway identifier identifying a doorway to a particular location at which the measuring apparatus is placed and a measuring apparatus identifier identifying the measuring apparatus placed at the location;
the information management method, when obtaining circumstance information about a particular item in a particular location, comprising the steps of:
obtaining from the circumstance-movement association master a doorway identifier associated with a measuring apparatus that obtains the circumstance information;
obtaining movement dates and times at which the item moved or passed through a location that matches the doorway identifier and determining the movement dates and times as information indicating the period during which the item stayed at the location where the measuring apparatus that obtains circumstance information is placed; and
obtaining from the circumstance history a measured value measured with the measuring apparatus during the period.

6. The information management method according to claim 5, further comprising the steps of:
holding permissible limits of a measured value for each item or each type of item measured with a measuring apparatus;
if a measured value that is out of the permissible limits is obtained with a measuring apparatus in a particular location,
obtaining a doorway identifier associated with the measuring apparatus from the circumstance-movement association master;
obtaining an item that stays in a location that matches the doorway identifier from the movement history; and
providing a warning if the item matches an item or a type of item associated with the permissible limits.

7. An information management method for a circumstance information management system that obtains and manages circumstance information in a particular location of items that are moving, the circumstance information management system having:
a movement history having at least an item identifier identifying an item, a location identifier identifying a location through which the item moved or passed, and information indicating movement dates and times at which the item moved or passed,
a circumstance history having at least a measuring apparatus identifier identifying a measuring apparatus that measures circumstance information about an item, a measured value measured with the measuring apparatus, and information about the date and time of the measurement, and
a circumstance-item association master having at least a measuring apparatus identifier identifying a measuring apparatus that measures circumstance information about an item, an item identifier of an item to which the measuring apparatus is attached, and a attachment period during which the measuring apparatus is attached to the item,
the information management method, when obtaining circumstance information about a particular item in a particular location, comprising the steps of:
obtaining from the movement history a period during which the item for which the circumstance information is to be obtained stayed at a particular location through which the item moved or passed;
obtaining an measuring apparatus identifier of a measuring apparatus associated with the item from the circumstance-item association master; and
obtaining from the circumstance history a measured value measured with a measuring apparatus that matches the measuring apparatus identifier during the period.

8. The information management method according to claim 7, further comprising the step of:
obtaining a measuring apparatus identifier of a measuring apparatus associated with the item from the circumstance-item association master;
obtaining from the circumstance history a measured value measured with a measuring apparatus that matches the measuring apparatus identifier during the period;
holding permissible limits of a measured value for each item or each type of item measured with a measuring apparatus;
obtaining an item identifier of an item associated with a particular measuring apparatus from the circumstance-item association master if a measured value that is out of the permissible limits is obtained with the particular measuring apparatus; and
providing a warning if the item matches an item or type of item that is associated with the permissible limits.
